(19) United States
(12) Patent Application Publication
(10) Pub. No.: US 2008/0018558 A1
(43) Pub. Date: Jan. 24, 2008

(54) Electronic display with photoluminescent wavelength conversion

(75) Inventors: Martin A. Kykta, Austin, TX (US); John R. Lewis, Bellevue, WA (US); Clarence T. Tegreene, Bellevue, WA (US); Christopher A. Wiklof, Everett, WA (US)

Correspondence Address: Christopher A. Wiklof;GRAYBEAL JACKSON HALEY LLP, Suite 350, 155-108th Avenue N.E., Bellevue, WA, 98004-5901, US

(73) Assignee: Microvision, Inc.

(21) Appl. No.: 11/784,191

(22) Filed: Apr. 4, 2007

Related U.S. Application Data
(60) Provisional application No. 60/789,046, filed on Apr. 4, 2006.
(60) Provisional application No. 60/789,047, filed on Apr. 4, 2006.

(51) Int. Cl. G09G 3/20; H01J 1/62

(52) U.S. Cl. 345/58; 313/483; 345/55

(57) ABSTRACT

Embodiments including methods and apparatuses for displaying an image including generating a first modulated and scanned excitation beam; generating a second modulated and scanned excitation beam; impinging the first and second modulated and scanned excitation beams onto a photoluminescent screen; and responsively converting the wavelengths of the first and second excitation beams into different corresponding third and fourth visible wavelength photoluminescent emissions, wherein the first modulated and scanned excitation beam is substantially prevented from stimulating photoluminescent emissions at the fourth visible wavelength and the second modulated and scanned excitation beam is substantially prevented from stimulating photoluminescent emissions at the third visible wavelength.

### CROSS-REFERENCE TO RELATED APPLICATIONS

The present application claims priority benefit from U.S. Provisional Application Ser. No. 60/789,946, entitled “LAYERED PHOTOLUMINESCENT DISPLAY SCREEN”, filed Apr. 4, 2006; and from U.S. Provisional Application Ser. No. 60/789,047, entitled “MULTICOLORED PHOTOLUMINESCENT DISPLAY SCREEN”, filed Apr. 4, 2006; both incorporated by reference to the extent they do not contradict material herein.

### TECHNICAL FIELD

The present disclosure relates generally to displays, and more particularly to video displays configured to produce at least one color channel via photoluminescent wavelength conversion.

### BACKGROUND

Electronic displays, including video displays fill an important roll in the technology infrastructure of our society. Scanned beam displays have shown promise in various applications. The availability of light sources at some wavelengths has heretofore hindered broad adoption of scanned beam display technologies.

### BRIEF DESCRIPTION OF THE DRAWINGS

FIG. 1 depicts photoluminescent wavelength conversion, according to an embodiment.

FIG. 2 is a diagrammatic view of a display including a scanned light beam activating a photoluminescent material to produce a first visible wavelength combined with a scanned light beam having a second visible wavelength, according to an embodiment.

FIG. 3 illustrates spectral properties of three photoluminescent systems, according to an embodiment.

FIG. 4 illustrates spectral properties of two photoluminescent systems, according to another embodiment.

FIG. 5 illustrates a display system operable to produce and use a composite scanning beam, according to an embodiment.

FIG. 6 illustrates a cross-sectional view of a three layer photoluminescent screen, according to one embodiment.

FIG. 7 is a cross-sectional view of a multilayer photoluminescent screen using filters between layers, according to an embodiment.

FIG. 8 illustrates a photoluminescent screen having arrayed photoluminescent emission regions, according to an embodiment.

FIG. 9 is a cross-sectional diagram of a display comprising a photoluminescent panel with a microlens array configured to focus light onto photoluminescent elements, according to an embodiment.

FIG. 10 is a cross sectional diagram of a photoluminescent display screen comprising a reflective “cuplet” structure to provide directional gain, according to an embodiment.

FIG. 11 is a cross-sectional diagram of a photoluminescent display screen comprising a refractive array, according to an embodiment.

FIG. 12 is a cross-sectional diagram of a photoluminescent screen comprising a shadow mask, according to an embodiment.

FIG. 13 shows plan views of arrays of photoluminescent systems and their placement on the substrate of FIG. 12, according to embodiments.

FIG. 14 is a diagram showing a display apparatus operable to launch excitation beams of light toward a photoluminescent display screen at particular angles, according to an embodiment.

### DETAILED DESCRIPTION

Apparatuses and methods are disclosed to provide information display using photoluminescent wavelength conversion, for example using a wavelength-converting display screen to display an image to a viewer. In various embodiments, wavelength conversion may be employed to convert non-visible, nearly non-visible or visible light at an excitation wavelength to photoluminescently emitted visible light at a different wavelength. According to an embodiment, a photoluminescent display may be configured to display a color image to one or more users.

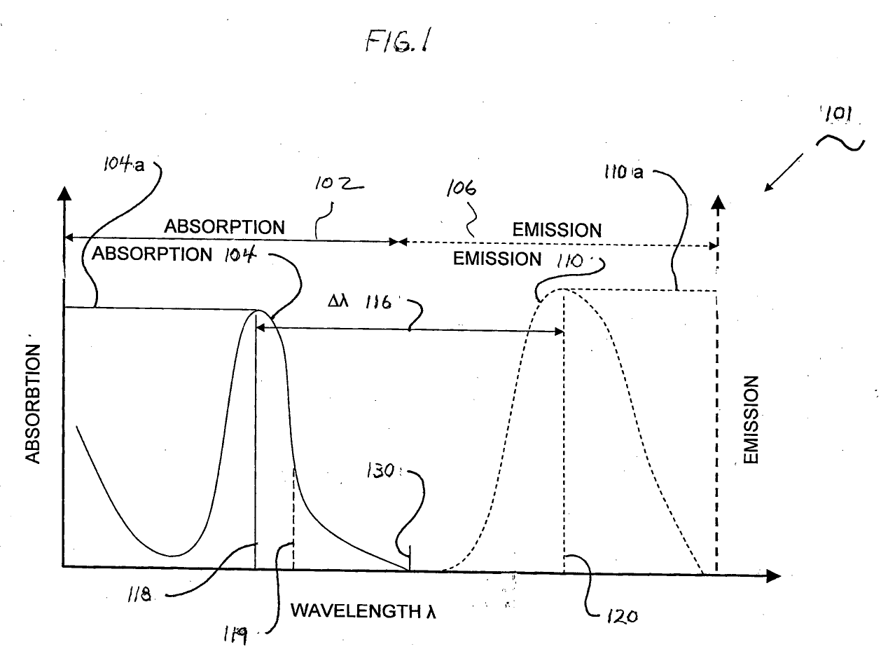

FIG. 1 illustrates a relationship 101 between excitation light 104 at a first wavelength and photoluminescent emission light 110 at a second wavelength, according to an embodiment. Light may impinge on a photoluminescent material. Light having a wavelength falling within an absorption range 102 may be absorbed by the photoluminescent material in a proportion corresponding to an absorption spectrum 104. Impinging light having a wavelength falling within a second wavelength range 106 may be substantially not absorbed. The second wavelength range 106 may be referred to as an emission range.

A magnitude of the absorption portion of the spectrum 104 is indicated on the left vertical axis. A magnitude of the emission portion of the spectrum 110 is indicated on the right vertical axis. Wavelength is plotted on the horizontal axis. An absorption spectrum 104 may be a physical property of a photoluminescent material. The absorption spectrum 104 may further be determined or influenced by a physical configuration of the photoluminescent material. An absorption spectrum 104 may have one or more peaks, with the exemplary system 101 being shown as having one absorption peak having a relative magnitude 104a at a wavelength 118.

The emission spectrum 110 may similarly have one or more peaks, with the exemplary system 101 being shown as having one emission peak having a relative magnitude 110a at a wavelength 120. A photoluminescent material possessing absorption and emission spectra, 104, 110 as indicated by FIG. 1 may convert energy incident upon and absorbed by the material to an emission of light having a spectrum 110. The emission spectrum 110 may be characterized by a peak wavelength 120 that may be referred to as a “photoluminescent emission wavelength.” The absorption and emission of light energy occurring within the photoluminescent material results wavelength conversion characterized by a change in wavelength, Δλ 116. Photoluminescent materials may be down-converting or up-converting (generally referencing photon energy). For simplicity of understanding (selected because the phenomenon corresponds to more generally familiar materials) FIG. 1 may be considered to depict a photoluminescent conversion from a shorter received wavelength range 102 to a longer emitted wavelength range 106.

The absorption spectrum 104 may substantially terminate at a maximum wavelength 130. Above the maximum absorption wavelength 130 there is substantially no excitation of the photoluminescent material that results in an emission of light.

Within this description of embodiments, the term “emission spectrum” and the term “photoluminescent emission wavelength” are used to describe the emitted light energy. It will be noted that a plurality of photoluminescent emission wavelengths may be included in an emission spectrum. At times, throughout this description of embodiments, these terms will be used synonymously to refer to the emitted light energy.

Narrow band light such as laser light at an excitation wavelength, incident upon a photoluminescent material may be represented by a spectral line, 119. Various devices may be used to generate the light represented at 119 including, for example, a violet or ultraviolet laser diode. Examples of typical devices are, but are not limited to Indium Gallium Nitride (InGaN) laser diodes, emitting near 408 nanometer (nm) (violet light), laser diodes emitting at the 380 nm (near-UV) band, laser diodes emitting at the 440 nm band. In one embodiment, the excitation wavelength emitted by the light source is within a range of non-visible wavelengths such as ultraviolet or approximately ultraviolet. In another embodiment, the excitation wavelength emitted by the light source is violet or nearly violet.

The light at the excitation wavelength 119 is absorbed by the photoluminescent material and is converted into emitted light having an emission spectrum 110 that is within a visible portion of the electromagnetic spectrum. According to various embodiments, emission spectra may correspond with a color such as red, green, blue, orange, etc. In a display using a plurality of photoluminescent emission channels, several materials, each possessing different absorption and emission spectrums, may be separately addressed to produce a desired magnitude of emission.

As indicated above, embodiments may be practiced using up-converting photoluminescent materials or down-converting photoluminescent materials. Embodiments may combine up-converting photoluminescent materials with down-converting photoluminescent materials. For example, one color channel may be produced by converting near ultra-violet light to blue with a second channel produced by converting infrared light to green. A third channel, for example, red, may be produced by a red laser diode directly.

According to an embodiment, a first portion of an image may comprise a first visible component of a scanned beam and a second portion of an image may comprise photoluminescent emission. According to an embodiment, the photoluminescent emission may be excited by a second component of the scanned beam.

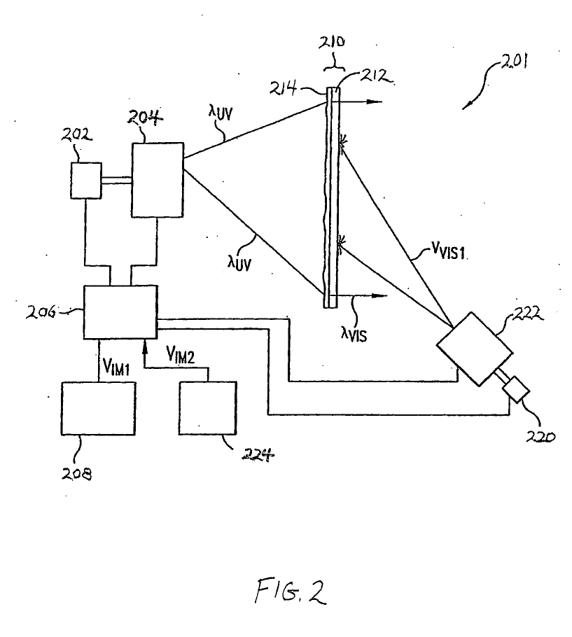

A diagram of a structure operable to combine a visible scanned beam component with a photoluminescent emission component is shown in FIG. 2. In FIG. 2, a scanned beam display 201 includes an ultraviolet (UV) light source 202 aligned to a scanner assembly 204. The UV source 202 may be a discrete laser, laser diode or LED that emits UV light.

Control electronics 206 drive the scanner assembly 204 through a substantially raster pattern. Additionally, the control electronics 206 activate the UV source 202 responsive to an image signal from an image source 208, such as a computer, radio frequency receiver, forward looking infrared radar (FLIR) sensor, videocassette recorder, or other conventional device.

The scanner assembly 204 is positioned to scan the UV light from the UV source 202 onto a screen 210 formed from a glass or plexiglass plate 212 coated by a photoluminescent structure 214 such as a phosphor layer. Responsive to the incident UV light, the phosphor layer 214 emits light at a wavelength visible to the human eye. The intensity of the visible light will correspond to the intensity of the incident UV light, which will in turn, correspond to the image signal. The viewer thus perceives a visible image corresponding to the image signal. One skilled in the art will recognize that the screen 210 effectively acts as an exit pupil expander that eases capture of the image by the user's eye, because the phosphor layer 214 emits light over a large range of angles, thereby increasing the effective numerical aperture.

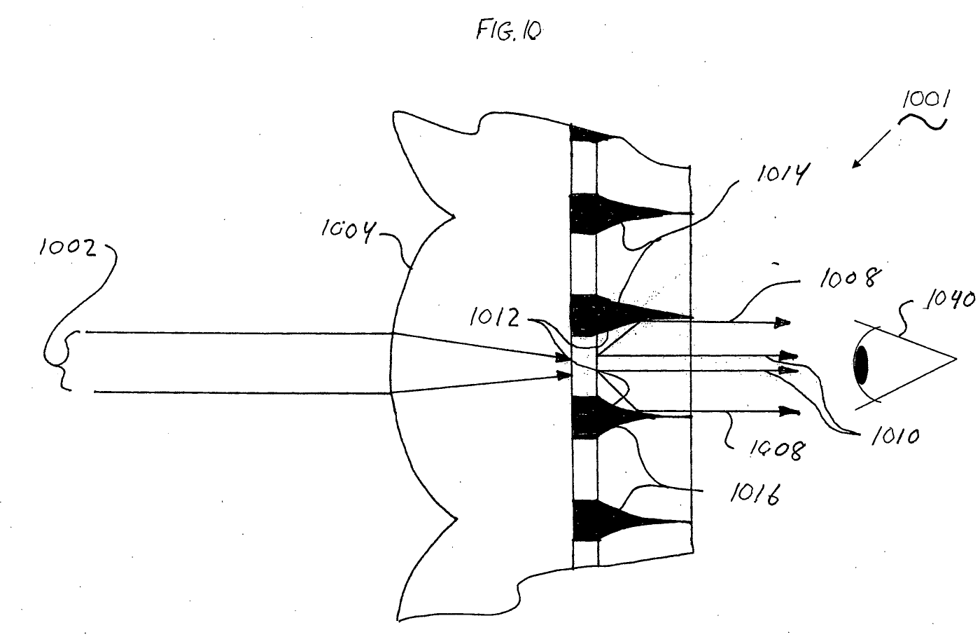

In addition to the scanned UV source, the embodiment of FIG. 10 also includes a visible light source 220, such as a red laser diode, and a second scanner assembly 222. The control electronics 206 control the second scanner assembly 222 and the visible light source 220 in response to a second image signal from a second image source 224.

In response to the control electronics, the second scanner assembly 222 scans the visible light onto the screen 210. However, the phosphor is selected so that it does not emit light of a different wavelength in response to the visible light. Instead, the phosphor layer 214 and the plate 212 are structured to diffuse the visible light. The phosphor layer 214 and plate 212 thus operate in much the same way as a commercially available diffuser, allowing the viewer to see the red image corresponding to the second image signal.

In operation, the UV and visible light sources 202, 220 may be activated independently to produce two separate images that may be superimposed. For example, in a motor vehicle, the first image source 208 may present various data or text from a sensor, such as a speedometer, while the second image source 224 may include a forward-looking infrared apparatus configured to aid night vision.

Although the display 201 of FIG. 2 is presented as including two separate scanner assemblies 204, 222, one skilled in the art will recognize that by aligning both sources to the same scanner assembly, a single scanner assembly may scan both the UV light and the visible light. According to an embodiment a first light source 202 and second light source 220 may be aligned to a beam combiner (not shown) to form a composite beam of light containing the individually modulated wavelength components emitted by the respective light sources. The output of the beam combiner may be aligned to a scanning mechanism 204 operable to scan the composite beam of light onto the screen 210. A visible component of the composite scanned beam, produced by the light source 220, may be scattered or diffused by the structure of the screen 210 while the non-visible component of the composite scanned beam, produced by the light source 202, is photoluminescently converted to a third wavelength by the photoluminescent structure 214. Thus a color rear-projection display may be formed. Alternatively, a color front-projection display may be formed. Alternatively, beams from the light sources 202, 220 may be scanned from the same or different scanning assemblies onto a single (front or rear) side of the screen 210 without first being combined into a composite beam by a beam combiner.

Regarding the display 201, one skilled in the art will also recognize that embodiments are not limited to UV and visible light. For example, the light sources 202, 220 may be two infrared sources if an infrared phosphor or other IR sensitive component is used. Alternatively, the light sources 202, 220 may include an infrared and a visible source or an infrared source and a UV source.

While the image sources 208 and 224 are described as separate inputs, they may be separate channels of a single input. For example, if the light source 202 is operable, through photoluminescent wavelength conversion, to produce green light and the light source 220 is operable to produce red light, then the image sources 208, 224 may respectively correspond to green and red channels of an RGB output of a video source. Of course, other color channels (such as blue) may similarly be received and produced by other light sources (not shown) using emission and/or photoluminescent wavelength conversion to form a full color display.

According to an embodiment a first portion of an image may comprise photoluminescent emission at a first visible wavelength and a second portion of an image may comprise photoluminescent emission at a second visible wavelength.

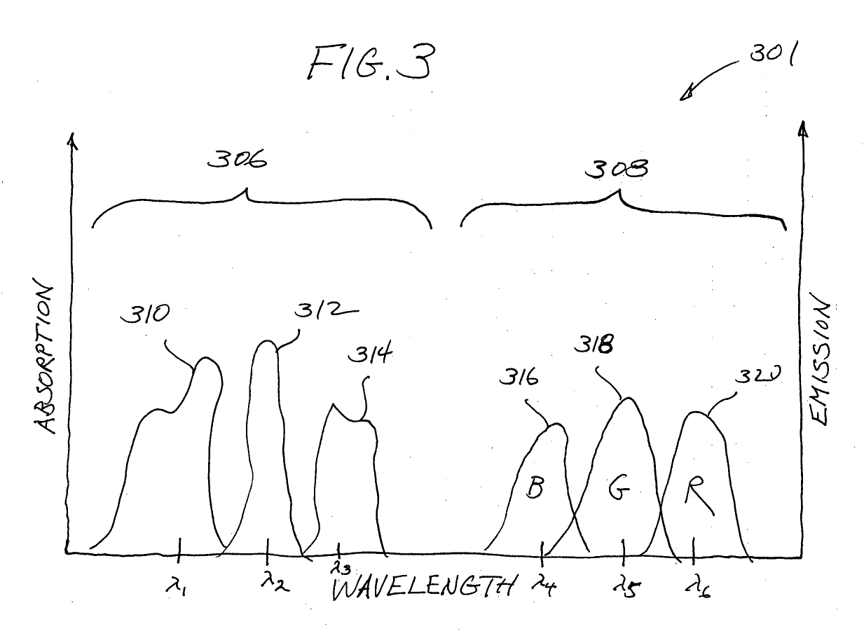

FIG. 3 illustrates spectral properties 301 of three photoluminescent systems, according to an embodiment. With reference to FIG. 3, wavelength is plotted on the horizontal axis, relative light absorption is indicated on the left vertical axis, and relative light emission is indicated on the right vertical axis. A system wavelength indicated at 330 divides the wavelength axis nominally into an absorption region 306 and an emission region 308. While the simplified system of FIG. 3 illustrates separate wavelength ranges for photoluminescent absorption and emission, absorption and emission may be intermixed or reversed from the indicated relationship.

The absorption region 306 may include the absorption spectra for a general number of color channels. In the embodiment displayed in FIG. 3, absorption spectra 310, 312, and 314 corresponding to three color channels are shown. The corresponding emission spectra for the photoluminescent materials are 316, 318, and 320, respectively.

A first photoluminescent material has an absorption spectrum 310 with a corresponding emission spectrum 316. A second photoluminescent material has an absorption spectrum 312 with a corresponding emission spectrum 318. A third photoluminescent material has an absorption spectrum 314 with an emission spectrum 320. The location of emission and absorption spectra on the wavelength axis is governed by the physics of a particular structure or material. While the relative positions of absorption and emission spectra are shown, for simplicity, as falling in corresponding ascending orders, the order of absorption spectra does not necessarily imply the same order of emission spectra in wavelength. Furthermore, as indicated above, one emission spectrum may be formed by down-conversion of an excitation wavelength while another emission spectrum is formed by up-conversion of an excitation wavelength. An exemplary excitation wavelength, λ₂, is shown falling within the absorption spectrum 312 of a second photoluminescent system, but outside the absorption spectra 310 and 314 of the first and third photoluminescent systems.

In various embodiments, a plural channel or multicolor photoluminescent display may be formed using photoluminescent materials that have different absorption spectra or similar absorption spectra. As will be explained, color channels may be separated across a screen, including by zone-coating, masking, etc, may be mixed within a screen, or may be separated as layers through the screen. In cases where photolumescent systems of two wavelength channels are spatially separated across a screen, it may not be necessary to select absorption spectra that are at least partially non-overlapping, as shown in systems 301. Alternatively, when absorption spectra are at least partially non-overlapping, as shown in FIG. 3, it may not be necessary to spatially separate the impingement of excitation energy to corresponding color channel regions. It is also possible to mix two channels that are spatially separated across a screen but which substantially do not have at least partially non-overlapping absorption spectra with a third channel that is not spatially separated across the screen but which does have an at least partially non-overlapping absorption spectrum.

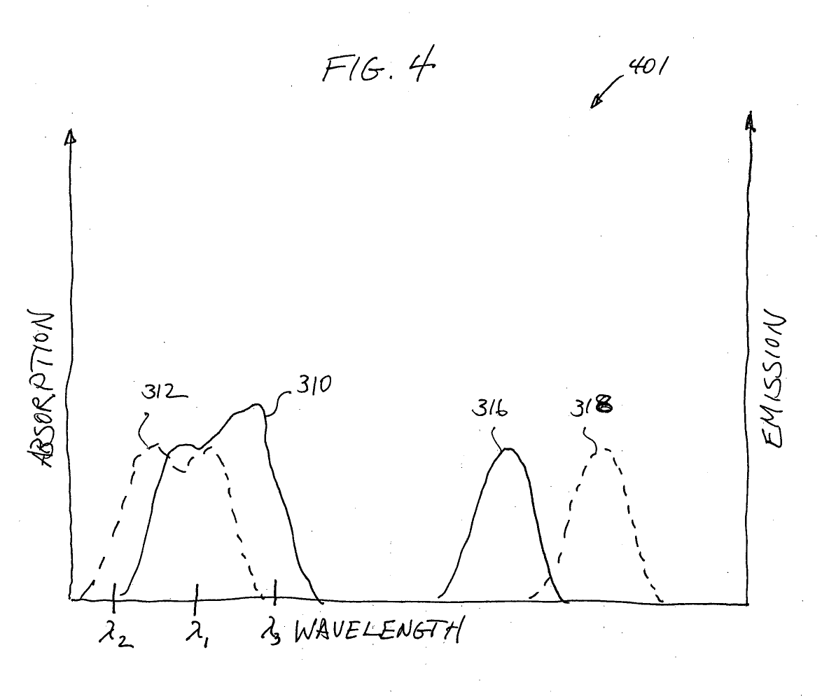

FIG. 4 illustrates two photoluminescent wavelength conversion systems 401 wherein the excitation wavelengths 310, 312 of the systems may be viewed as substantially overlapping or separate, depending upon the excitation wavelength. A first photoluminescent system may have an absorption curve 310 that, when excited, emits light according to emission curve 316. A second photoluminescent system may have an absorption curve 32 that, when excited, emits light according to the emission curve 318.

Some possible excitation wavelengths, illustrated as λ₁, may correspond to portions of the respective absorption spectra 310, 312 wherein significant light absorption or pumping occurs in both systems. Light at wavelength λ₁ impinging on a location including both systems corresponding to the absorption spectra 310 and 312 may be expected to produce both emission spectra 316 and 318, the proportion of which may be determined by the relative abundance of the two photoluminescent systems, the relative absorption efficiency, the relative conversion efficiency, the depth of excitation photon penetration, environmental effects such as temperature that may affect relative conversion efficiency, and/or any interaction effects between the systems. Other possible excitation wavelengths, illustrated as λ₂ and λ₃, may fall within portions of the respective absorption spectra 312, 310 that are substantially non-overlapping. For example, Light at wavelength λ₂ impinging on a location including both systems corresponding to the absorption spectra 310 and 312 may be expected to produce substantially the emission spectrum 318, because λ₂ falls outside the absorption spectrum 310. Similarly, light at wavelength λ₃ impinging on a location including both systems corresponding to the absorption spectra 310 and 312 may be expected to produce substantially the emission spectrum 316, because λ₃ falls outside the absorption spectrum 312. Of course, light at either λ₁ or λ₂ that impinges upon a location having only the system corresponding to the absorption spectrum 312 may be expected to produce substantially only emitted light having the characteristic emission spectrum 318. Similarly, light at either λ₁ or λ₃ that impinges upon a location having only the system corresponding to the absorption spectrum 310 may be expected to produce substantially only emitted light having the characteristic emission spectrum 316.

Thus, there are two ways of selectively emitting one or the other of the emission spectra 316 and 318. One may select an excitation wavelength (e.g. λ₃ or λ₂ ) having spectral selectivity for the corresponding photoluminescent systems. Alternatively, one may select a wavelength that may or may not be spectrally selective (e.g. λ₁ or λ₃ if one wishes to excite the system having the absorption spectrum 310), but which is spatially selected to impinge on a location corresponding to one system (e.g. 310) but not the other system (e.g. 312). Combinations of the two effects may be combined, and may be especially useful for systems having a limited number of excitation wavelengths, a relatively large number of photoluminescent systems, and/or a limited ability to spatially differentiate photoluminescent systems.

The selection of excitation wavelengths may be determined according to the availability, cost, form factor, reliability, modulatability, etc. of various laser sources. Returning briefly to FIG. 1, an excitation wavelength corresponding to 118 may be more strongly absorbed, and hence may provide more efficient conversion to the emission curve 110 than an excitation wavelength corresponding to 119. However, while a laser light source operable to emit excitation energy at a wavelength 118 may be unavailable, costly, etc., a laser light source corresponding to 119 may be a better choice because of factors listed above or other factors, even though it may nominally produce the emission spectrum 110 less efficiently because of reduced absorption. Additionally, as will be appreciated below, structure may be implemented to effectively improve the absorption efficiency at wavelength 119.

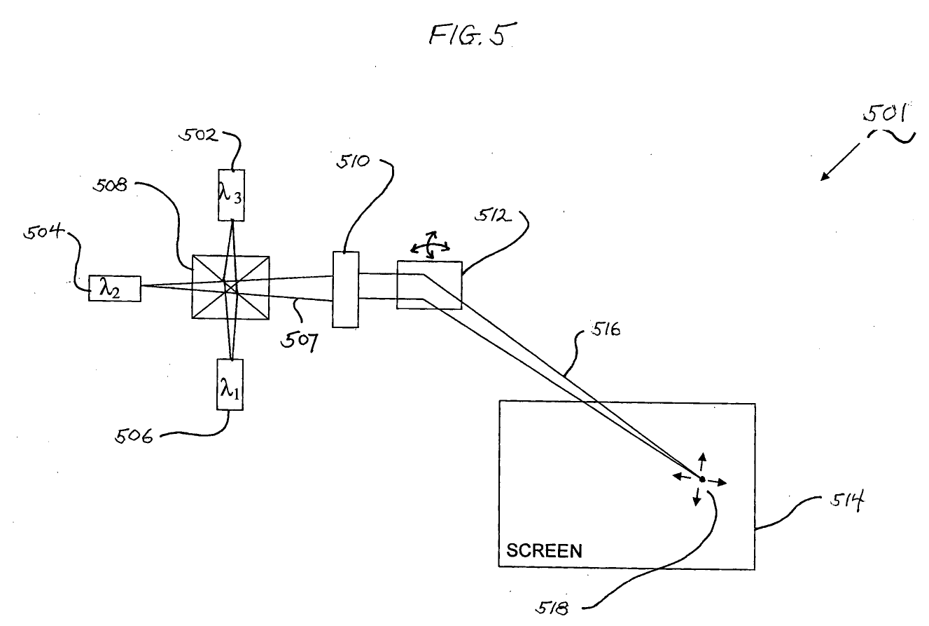

Returning to the discussion of the embodiment 201 illustrated in FIG. 2, photoluminescent excitation and/or directly viewable beams may be combined into a composite scanning beam, for example using a beam combiner. FIG. 5 illustrates an embodiment of a display system 501 operable to produce and use a composite scanning beam.

FIG. 5 illustrates, according to an embodiment, a scanned beam photoluminescent display system 501 including light sources 502, 504, and 506 whose modulated output beams may be combined into a composite modulated output beam 507 with a beam combiner 508. With reference to FIG. 5, a general number of light sources indicated by 502, 504, and 506 are operable to emit light. The emitted light of at least one of the light sources 502, 504, 506 may correspond to an excitation wavelength used by a photoluminescent system in the display 501. In one embodiment, the light sources 502, 504, and 506 are laser diodes configured to emit light at different excitation wavelengths. The amplitude of the light emitted at the excitation wavelengths is modulated by control electronics responsive to image information from an image source not shown, as described previously. The light emitted by the light sources 502, 504, and 506 is combined into a composite beam 507 by beam combining optics 508. The combined beam 507 may be shaped by an optical element 510 and scanned by scanner 512 onto a photoluminescent screen 514.

Excitation wavelengths within the combined scanned beam 516 excite corresponding photoluminescent systems comprising the screen 514, causing the photoluminescent systems to absorb the light at the excitation wavelengths and then to emit light at corresponding visible photoluminescent emission wavelengths at locations 518 impinged by the beam 516. Conversion of light from a first wavelength to a second wavelength may be accomplished using fluorescent photoluminescent materials, phosphorescent photoluminescent materials, nanoparticles such as quantum dots, etc.

For some embodiments, a frame rate of about 60 Hz may be used. Thus, photoluminescent system persistence time may be selected to be approximately less than or equal to the frame period (e.g. 1/60 sec.) for a display having all pixels addressed each frame time (e.g. a progressive scan display), or approximately equal to or less than an interleave period (e.g. 1/30 sec.) for a display using scan line interleaving.

Light sources, 502, 504, and 506 may each emit a spectrum of light characterized and referred to as light emitted at an excitation wavelength. Those of skill in the art will appreciate that the width in wavelength of an output spectrum of a light source may differ according to the light source. For example a thermal source may emit a broad spectrum (e.g. that is limited in width using one or more filters such as birefringent filters), a LED source may emit a somewhat narrower spectrum, and a coherent source such as a laser may emit a line spectrum as depicted in figures above. Reference to an excitation wavelength may be conveniently associated with a dominant wavelength of an output spectrum of a light source or a wavelength within the output spectrum of the light source used to stimulate photoluminescent emission. In cases where filters or other apparatuses or operational methods are used to limit the pass band or emission width of a light source, such filters, apparatuses, or methods may be considered to be a part of the light source, whether or not closely physically associated with the light source. For example, plural pass bands may be formed in the composite beam 507 following combining of the individual beams.

The scanner assembly 512 may be operated in a non-resonant or in a mechanically resonant mode. One example of a resonant scanner described U.S. Pat. No. 5,557,444 to Melville et al., entitled MINIATURE OPTICAL SCANNER FOR A TWO-AXIS SCANNING SYSTEM, which is incorporated herein by reference. Other scanning assemblies, such as acousto-optic scanners, etc. may alternatively be used. A MEMS scanner, which may be preferred in some applications due to its low weight and small size may be uniaxial or biaxial. An example of a biaxial MEMS scanner is described in U.S. Pat. No. 5,629,790 to Neukermans, et al entitled MICROMACHINED TORSIONAL SCANNER, which is incorporated herein by reference.

The display 501 may take many forms, for example the screen 514 may be directly viewed by a viewer, or alternatively imaging optics (not shown) may project the image formed on the screen 514 to the viewer. For example, the imaging optics may include more than one lenses or diffractive optical elements operable to project an image onto the retina, optionally through relay optics, onto the retina of a viewer, such as to form a retinal display. Retinal displays, in turn, may take many forms, including a head-mounted display (HMD), a heads-up display (HUD), etc. One example of a retinal display is a scanned beam display such as that described in U.S. Pat. No. 5,467,104 of Furness et al., entitled VIRTUAL RETINAL DISPLAY, which is incorporated herein by reference. An example of a fiber-coupled retinal scanning display is found in U.S. Pat. No. 5,596,339 of Furness e. al., entitled VIRTUAL RETINAL DISPLAY WITH FIBER OPTIC POINT SOURCE which is incorporated herein by reference. Similarly, projection optics may project the image formed on the screen 514 onto another viewing surface such as a projector screen.

Direct view screens may similarly be used in a variety of applications. For example, an automotive instrument cluster or panel may be formed by projecting one or more scanned beams onto a photoluminescent panel 514, which may for example be embedded in the dashboard of a vehicle. Perhaps more familiarly, a photoluminescent panel 514 may comprise a computer monitor, a television monitor, a portable video player monitor, etc.

As indicated above, combinations of excitation wavelengths and photoluminescent systems may be selected to provide individual modulation of color channels including selected photoluminescent wavelength conversion simply by selecting a particular wavelength for excitation. According to some embodiments, the photoluminescent systems may be intermixed on the screen 514. Alternatively, it may be desirable to arrange the photoluminescent systems in two or more layers on the screen 514. Such an arrangement may aid, for example, in reducing cross-talk between photoluminescent systems.

According to an embodiment, a multilayered photoluminescent screen may be used to display an image to user.

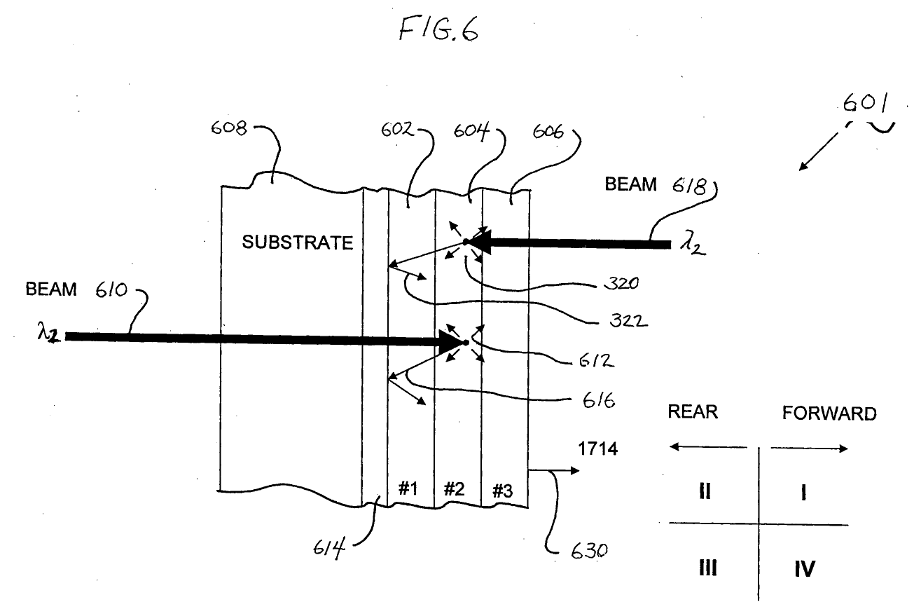

FIG. 6 illustrates a cross-sectional view of a three layer photoluminescent screen 601 according to one embodiment. A first photoluminescent layer 602 is disposed proximate to a second photoluminescent layer 604, which is disposed proximate to a third photoluminescent layer 606. In one embodiment, the absorption spectra 310, 312, and 314, (FIG. 3) correspond to the photoluminescent layers 602, 604, and 606, respectively. A beam of light 610 at a second excitation wavelength λ₂ falling within the absorption curve 312 is incident upon the screen, impinging on the first photoluminescent layer 602. Other beams of light corresponding to excitation of absorption spectra 310 and 314 are not shown so that the operation of the second excitation wavelength used to excite the second layer may be clearly illustrated.

The beam of light 610 passes through the first photoluminescent layer 302 without absorption since the second excitation wavelength is greater than the maximum absorption wavelength of the absorption spectrum 310 of the first layer. The beam of light 610 is absorbed by the second layer 604, causing an emission of light at a second photoluminescent emission wavelength as indicated by 612 and 616. Emitted light 612, 616 may comprise substantially omnidirectional emission, a portion of which travels out of the display screen in a general direction as indicated by 630 (although in many cases, direction 630 may be more properly referred to as substantially a hemispherical direction, wherein light is emitted hemispherically toward the right, with or without gain in a particular direction). Light emitted in a rear direction, indicated by 616, may be recovered by reflection off of a layer of material 614 disposed between the first photoluminescent layer 602 and a substrate 608. In one embodiment, the substrate 608 is a layer of glass. In one embodiment, the layer of material 614 is a selective reflector configured to pass light at excitation wavelengths and to reflect light at photoluminescent emission wavelengths. Such reflective behavior of the layer of material 614 results in the reflection of backward-emitted light 616 as indicated by the arrow. Reflection of light 616 by the layer of material 614 may results in more light being directed from the display screen in a forward direction, along departure angles that lie in the first (I) and fourth (IV) quadrants. The layer of material 614 may be comprised, for example, of a dielectric coating. In one embodiment, the layer of material 614 is multilayered dielectric film including Titanium Dioxide (TiO₂) and/or Silicon Dioxide (SiO₂). Such coatings may be combined to make filters that have various pass bands in wavelength.

Alternatively, the display screen may be illuminated by a beam of excitation light, at a photoluminescent excitation wavelength, traveling from right to left as indicated by 618. Such a beam of light at a photoluminescent excitation wavelength λ₂ passes through the top layer 606 corresponding to the absorption spectrum 314 (FIG. 3) because it lies outside the absorption spectrum 314. The beam is absorbed by the second photoluminescent layer 604, which results in an emission of light at a photoluminescent emission wavelength 318 (FIG. 3) as indicated by 620 and 622. It may be noted that a general number of layers can be used in a multilayered photoluminescent display screen.

In one embodiment, the layers of photoluminescent material indicated by 602, 604, and 606 may have a thickness of less than a micron or they may have a thickness greater than a micron, depending on a particular material and a desired absorbance for a particular layer. In one embodiment, a layer thickness of 0.5 micron illuminated with a beam of light having a spot diameter of 15 microns results in negligible loss in resolution. One trade-off with thicker photoluminescent layers 602, 604, and 606 may include loss of apparent resolution. The apparent loss in resolution may correspond, for example, by apparent differences in lateral position of rays 612 emitted in a forward direction (I, IV) vs. the reflection of rays 616 emitted in a rearward (II, III) direction.

Various photoluminescent materials can be used in the layers, some examples of materials are, but are not limited to, rare earth ions in glass or crystals, such as Neodimium doped Yttrium Aluminum Garnet Nd:YAG or dyes in solution or polymers. The organic compound Perylene, organic dyes such as Coumarin, Fluorescein, and Rhodamine can be used in various embodiments for the photoluminescent material. In one embodiment, three laser dyes that produce emissions of red, green, and blue light are Rhodamine 101 (excited with a excitation wavelength at 380 nm, emit at a photoluminescent emission wavelength of 640 nm “red”), Coumarin 466 (excited with a excitation wavelength of 405 nm, emit at a photoluminescent emission wavelength of 460 nm “blue”), and Coumarin 522 (excited with a excitation wavelength of 420 nm, emit at a photoluminescent emission wavelength of 525 nm “green”).

In various embodiments, nanoparticles such as quantum dots may be used to control the magnitude of the photoluminescent emission wavelength (color) of the light energy emitted by the photoluminescent material and/or replace dyes or phosphors as photoluminescent materials. Quantum dots of smaller size may emit light at shorter photoluminescent emission wavelengths (nearer the blue end of the visible spectrum) and quantum dots larger size may emit light at longer photoluminescent emission wavelengths (nearer the red end of the visible spectrum). In various embodiments, suitably sized quantum dots are configured into films that emit light at selected photoluminescent emission wavelengths, such as but not limited to red, green, and blue.

An absorbance of a layer may be scaled by varying the product of concentration, molecular weight, and path length, where concentration and molecular weight refer to a photoluminescent material and the path length refers to the thickness of the photoluminescent layer.

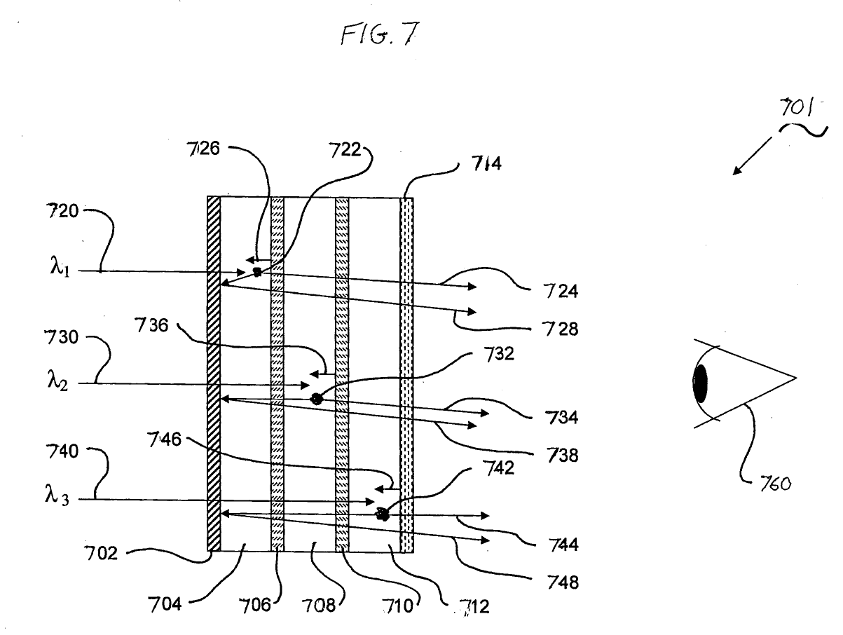

FIG. 7 is a cross-sectional view of a multilayer photoluminescent screen 701 using filters between layers according to an embodiment. While the photoluminescent screen 701 may, in certain embodiments, be self-supporting, a substrate (not shown) may be used to support the layers shown. The substrate should be at least partially transparent to allow the transmission of visible photoluminescently emitted light (if located on the right side of the cross-section 701), and/or to allow for the transmission of excitation light (if located on the left side of the cross-section 701). The multilayered photoluminescent screen 701 may be selectively illuminated by one or more beams of light 720, 730, and 740 respectively comprising first, second, and third photoluminescent excitation wavelengths λ₁, λ₂, and λ₃. The beam 720 comprising the first excitation wavelength λ₁ is absorbed by a photoluminescent entity 722 in a first photoluminescent layer 704, resulting in an emission of light at a first photoluminescent emission 724 at wavelength λ₄. Light energy 724 travels toward a viewer 760. Light energy that is not absorbed during a first pass through the first photoluminescent layer 704 may be reflected back through the first photoluminescent layer 704 by a layer of material 706. The layer of material 706 is, in one embodiment, configured to pass light above a maximum absorption wavelength of the first photoluminescent layer 704 and to reflect light below the maximum absorption wavelength of the first photoluminescent layer 704. Light at the first excitation wavelength that is not absorbed by the first pass through the photoluminescent layer 704 but is reflected from the layer of material 706 is indicated at 726. Light 726 may travel at least part way through the first photoluminescent layer 704 a second time, facilitating further absorption and emission of light at the first photoluminescent emission wavelength λ₄.

In one embodiment, a layer 702 is disposed on the first photoluminescent layer of material 704. The layer of material 702 may be configured, in one embodiment, to pass light below a particular wavelength and to reflect light above the particular wavelength. In one embodiment, the particular wavelength is selected to allow beams 720, 730, and 740 at three excitation wavelengths λ₁, λ₂, and λ₃ to pass, and to reflect visible light emitted by the photoluminescent layers. Emission of light 722 that travels back toward the layer 702 is reflected thereby resulting in more light 728 at the first photoluminescent emission wavelength being directed toward the viewer 760 of the display.

Similarly, light 730 at the second excitation wavelength λ₂ is absorbed by a second photoluminescent layer 708, resulting in an emission of light at a second photoluminescent emission wavelength λ₅ indicated at 734. Excitation light energy 730 that is not absorbed by the second photoluminescent layer 708 is reflected back through the second photoluminescent layer 708 as reflected excitation beam 736 by a layer of material 710. The layer of material 710 is, in one embodiment, configured to pass light above a maximum absorption wavelength of the second photoluminescent layer 708 and to reflect light below the maximum absorption wavelength of the second photoluminescent layer 708. Light at the second excitation wavelength λ₂ that is not absorbed by the second photoluminescent layer 708 but is reflected from the layer of material 708 is indicated at 736. Light energy 736 can travel across the second photoluminescent layer 708 a second time facilitating further absorption and emission of light at the second photoluminescent emission wavelength λ₅. Emission of light from photoluminescent entity 732 that travels back toward the layer 702 is reflected thereby resulting in more light 738 at the second photoluminescent emission wavelength λ₅ being directed toward the viewer 760 of the display.

Light 740 at the third excitation wavelength λ₃ passes through the selective reflective layer 702, the first photoluminescent layer 704, the selective reflective layer 706, the second photoluminescent layer 708, and the selective reflective layer 710 substantially unimpeded, and is absorbed by a third photoluminescent layer 712. A photoluminescent entity 742 within the third photoluminescent layer 712 responsively emits light at a third photoluminescent emission wavelength λ₆ indicated at 744. Incident excitation light energy 740 at the third photoluminescent excitation wavelength λ₃ that is not absorbed by the third photoluminescent layer 712 on the first pass may be reflected back into the third photoluminescent layer 712 as reflected excitation beam 746 by a layer of material 714. The layer of material 714 is in one embodiment, configured to pass light above a maximum absorption wavelength of the third photoluminescent layer 714 and to reflect light below the maximum absorption wavelength of the third photoluminescent layer 714. Light at the third excitation wavelength λ₃ that is not absorbed by the third photoluminescent layer 712 but is reflected from the layer of material 714 is indicated at 746. Light 746 may travel across the third photoluminescent layer 714 a second time facilitating further absorption and emission of light at the third photoluminescent emission wavelength λ₆. Light emitted by the photoluminescent entity 742 that travels back toward the layer 702 is reflected thereby resulting in more light 748 at the third photoluminescent emission wavelength λ₆ being directed toward the viewer 760 of the display.

In various embodiments, the layer of material 714 may provide an anti-reflective coating for the display. In embodiments, the layer of material 714 may reflect light below the lowest emission wavelength λ₄ and above the highest excitation wavelength λ₃ thereby protecting a viewer from light that may be harmful to the viewer's eyes. In embodiments, the layer of material may be configured to allow relatively narrow bands of emitted light near λ₁, λ₂, and λ₃ infrared to pass while absorbing other intermediate wavelengths, thus providing reduced glare by broadband ambient light.

The selectively reflective layers of material, 702, 706, 710, and 714 may be made using multilayered dielectric coatings as described above. Multilayered dielectric coatings may provide for flexibly designed filters having pass bands that are tailored for specific applications and embodiments.

According to an embodiment, display may include a plurality of photoluminescent systems configured to selectively emit a corresponding plurality of emission wavelengths, wherein the photoluminescent systems are arranged to be selectively addressed or energized by spatial differentiation across a display screen or intermediate image plane.

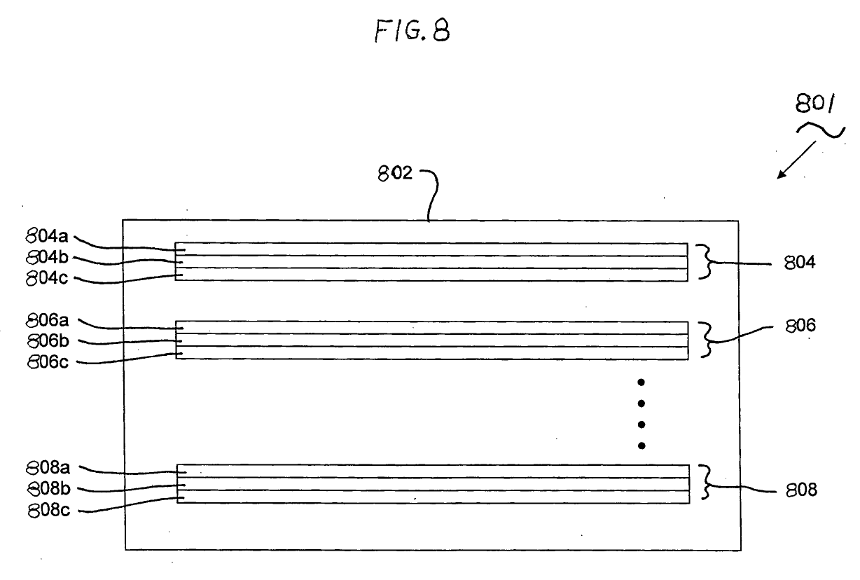

FIG. 8 illustrates a photoluminescent screen 801 having arrayed photoluminescent emission regions configured to emit corresponding wavelengths, according to an embodiment. The photoluminescent screen 801 includes a substrate 802 on which may be formed photoluminescent emission regions, for example configured to respectively emit red, green, and blue photoluminescent emissions. A first group of interstitially located lines of photoluminescent systems is indicated at 804. A second group of interstitially located lines of photoluminescent systems is indicated at 806. The substrate 802 may include a general number of groups of interstitially located lines of photoluminescent systems, an ultimate group being indicated at 808. In one embodiment, each group of lines, 804, 806, and 808 is used to display a line of pixels within a frame of an image. Taken together, the groups of lines 804, 806, through 808 present an image to a user.

Responsive to one or more scanned beam(s) of light, the photoluminescent system within line 804a emits visible light having a wavelength corresponding to a color red. The scanned beam(s) of light is modulated during the scan along line 804a to provide variation in the light emitted by the photoluminescent system 804a as a function of position, thereby providing amplitude variation in the red emission. Similarly the scanned beam(s) of light excites a line of photoluminescent system 804b, selected to provide a green emission, and a line of photoluminescent system 804c selected to provide a blue emission. The other groups of lines, 806 and 808 are made up of individual lines of photoluminescent system, i.e., 1306a, 1306b, 1306c, 1308a, 1308b, and 1308c selected to provide light at visible colors as described above. Modulation of the amplitude of the scanned beam(s) of light results in a display of image information on the photoluminescent display screen 801.

In various embodiments, different patterns are used for the phosphor on the photoluminescent display screen 801. In one embodiment, the photoluminescent system lines within the groups (804, 806, 808), for example 804a, 804b, and 804c, are separated by light absorbing material to prevent undesirable artifacts in the image displayed, such as cross-talk between lines. In another embodiment, the photoluminescent system lines within the groups (804, 806, 808), for example 804a, 804b, and 804c, are formed as a series of dots rather than a continuous line of photoluminescent system. Such a patterning of dots may improve resolution of a display when using some phosphorescent materials.

In various embodiments, multiple beams of light can be scanned across the photoluminescent display screen 801. In one embodiment, three light beams are scanned simultaneously. Each light beam is aligned to illuminate a given color photoluminescent system or phosphor displaying red, green, or blue pixel information. In another embodiment, a single light beam scans the display screen 801 illuminating the line 804a, followed by 804b, followed by 804c; writing the image information pertaining to each color of a line of image information sequentially. Other visible colors may be emitted by the photoluminescent display screen 801.

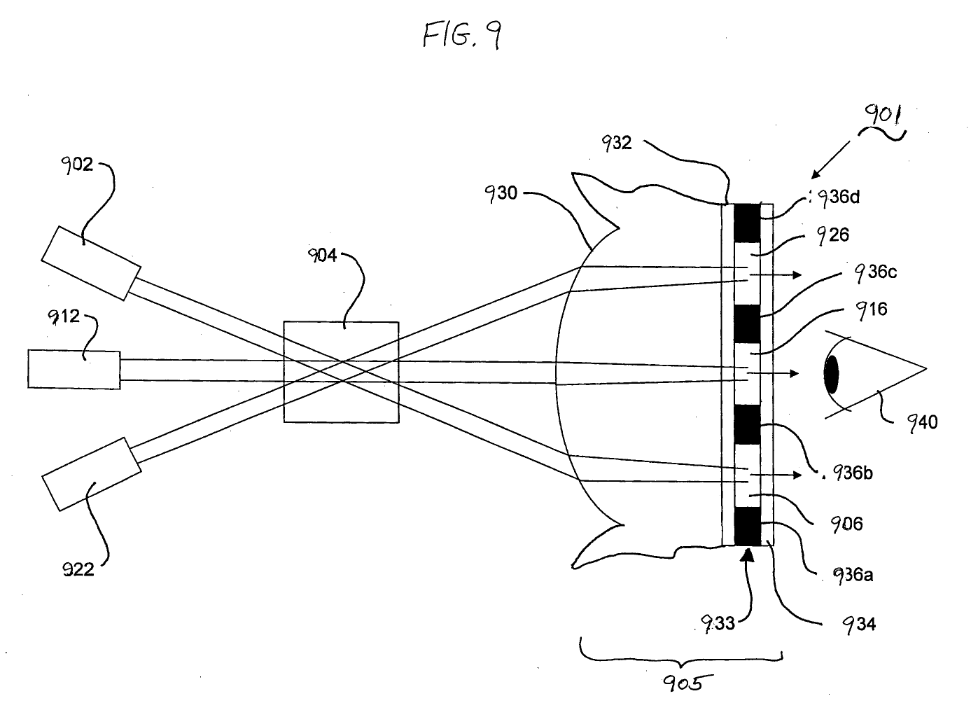

In various embodiments, screen gain may be obtained for a photoluminescent display screen using a lenslet or lenticular array. FIG. 9 is a diagram of a display 901 comprising a photoluminescent panel with a microlens array configured to focus light onto photoluminescent elements according to an embodiment. Light sources 902, 912, and 922 emit light at excitation wavelengths. In one embodiment, the light sources 902, 912, 922 emit light in the non-visible ultraviolet band (UV) or nearly ultraviolet band. Typical devices used for light sources 902, 912, and 922 may include laser diodes and/or frequency doubled lasers. In another embodiment, one or more of the light sources 902, 912, 922 emit light in the visible band. In another embodiment, one or more of the light sources 902, 912, 922 emit light in the infrared band. In yet another embodiment, one or more light sources emit light in one band such as the UV band and/or the IR band and one or more light sources emit light in the visible band.

The light emitted at the excitation wavelengths is scanned by a scanner 904 onto a photoluminescent display screen 905. The photoluminescent display screen 905 may include an array of microlenses 930. Photoluminescent materials 906, 916, and 926 may be disposed on the microlens 930 to form a colored picture element (pixel). Light from the light source 902 is directed by the scanner 904 to the microlens 930, where the light is focused onto photoluminescent material 906. Similarly, light from the light source 912 is directed by the scanner 904 to the microlens 930, where the light is focused onto photoluminescent material 916, and light from the light source 922 is directed by the scanner 904 to the microlens 930, where the light is focused onto photoluminescent material 926.

Light arriving from the light sources 902, 912, and 922 at different convergence angles relative to the microlens 930 facilitates selectively directing and focusing of the light by the microlens 930 onto the respective photoluminescent materials 906, 916, and 926. The photoluminescent materials convert light incident thereon to emissions of light that are shifted up or down in wavelength.

Photoluminescent materials 906, 916, 926 may be selected to provide emissions of light that are separated in wavelength to produce RGB output, for example. Thus, in various embodiments, multicolored light is emitted by the pixel constructed as shown in FIG. 9. Pixels may be formed by illuminating a single photoluminescent material with a light source at an excitation wavelength in conjunction with a microlens, resulting in a gray scale display utilizing an emission of light at a single color such as but not limited to green, orange, red, etc. Multicolored pixels may be formed with a plurality of photoluminescent elements, such as the three color pixel described in conjunction with FIG. 9.

In one embodiment, the photoluminescent materials 906, 916, and 926 are surrounded by a light absorbing material 936a, 936b, 936c, and 936d. The light absorbing material absorbs incident light and may reduce cross-talk between photoluminescent elements. According to some systems, cross-talk may be reduced by preventing an emission from one photoluminescent material from exciting a neighboring photoluminescent material. Additionally, the light absorbing material can prevent an incident excitation wavelength light beam from exciting the wrong photoluminescent element due to misalignments of the light beam and the photoluminescent materials. For example, some part of the system, such as the light source 922, the scanner 904, etc. may be misaligned, mis-synchronized, vibrated, etc. in a manner that could result in the scanned beam falling partially on the intended photoluminescent material 926 and the light absorbing material 936c instead of falling on a neighboring photoluminescent material due to the misalignment.

In one embodiment, a layer of material, indicated at 932 is disposed between the microlens 930 and the layer 933 that contains the photoluminescent materials. The layer of material 932 is configured to pass light from the light sources 902, 912, and 922 (at one or more excitation wavelengths) and to reflect light emitted from the photoluminescent materials at photoluminescent emission wavelengths. The layer of material 932, so configured, permits light at the photoluminescent emission wavelengths otherwise emitted in a direction away from a viewer 940 to be reflected and directed to the viewer in a manner similar to that described in conjunction with FIGS. 6 and 7.

In various embodiments, a layer of material 934 is configured as a filter and/or as a protective coating for the photoluminescent display screen. In one embodiment, the layer of material is configured to pass light at visible wavelengths and to reflect light at excitation wavelengths. Such a configuration protects a viewer from light at the excitation wavelength(s). In one embodiment, the layer of material 934 is configured to pass light above a particular wavelength and to reflect light below the particular wavelength. In one embodiment, the particular wavelength is the minimum visible wavelength of interest that is part of the emissions from the photoluminescent materials. Those of skill in the art will realize that the layer 934 can be configured in a variety of ways consistent with the desired operation of the display screen. In some embodiments, an emission (photoluminescent emission wavelength) from the photoluminescent materials is at infrared wavelengths; in such configurations it may be desirable to configure the layer of material 934 to pass infrared and to reflect wavelengths below infrared. Thus, a particular wavelength is adjustable within the parameters of a particular system design. In other embodiments, the layer of material is configured to act as a band pass filter. In various embodiments, the layers of material 932 and 934 are made using dielectric coatings as described above in a previous section.

The view presented in FIG. 20 is a cross-sectional view of one pixel of a display screen that may include a plurality of pixels. In various embodiments, as is known to those of skill in the art, the microlens 930 may extend in one or two dimensions, creating a microlens array. The scanner 904 scans light from the light sources 902, 912, and 922 over the microlens array to display an image to the viewer 940.

In one embodiment, the microlens array is used during the fabrication of the photoluminescent display. The selective placement of light by the microlens is used to expose photoresist during the photolithographic steps of fabrication. In one embodiment, light sources and the microlens are used to expose a positive photoresist in the locations where the photoluminescent material will be deposited. After exposure, the positive photoresist is removed during developing and the photoluminescent material is deposited. Either positive or negative photoresist can be used and light sources can be positioned accordingly to focus light through the microlens to expose the desired regions of photoresist. As is know to those of skill in the art, successive photolithographic steps of exposure to light, etching, deposition of material, planarization, etc. are used to make a display screen.

For example, in one embodiment, a layer of positive photoresist covers the microlens 930. Light from the light source 922 is used to expose the positive photoresist over the region of 926. Chemical etching removes positive photoresist from over the region of 926 and etches down to form a void. In a following step the photoluminescent material is deposited into the void to form photoluminescent material 926.

In another example, a negative photoresist may be applied. Light from the light sources 902, 912, 922 illuminates the photoresist, fixing the regions where photoluminescent material has been deposited previously. Subsequent developing may remove the photoresist from the regions where the light absorbing material 936a, 936b, 936c, 936d will be applied. In a subsequent step the light absorbing material 936a, 936b, 936c, 936d is deposited. Many variations of using the microlens array during the manufacturing step of the display are possible and are contemplated to be within the scope of the teachings presented herein.

FIG. 10 shows a cross section of a photoluminescent display screen 1001 comprising a reflective “cuplet” structure to provide directional gain according to an embodiment. Light 1002 at an excitation wavelength from a light source impinges on a microlens 1004 and is directed by the microlens 1004 to an element of photoluminescent material 1006. Light at the excitation wavelength is absorbed by the photoluminescent material and an emission of light at a higher wavelength occurs (photoluminescent emission wavelength). As described earlier, emission of light by a photoluminescent material is omnidirectional and, as such, light travels in directions that might not be beneficial to a viewer of a display screen. In one embodiment, a cross-sectional view of a reflective structure in the shape of a cup or cone is indicated at 1012. The reflective structure 1012 collects light emitted by the photoluminescent material 1006 and directs the light into a field of view of a viewer 1040. Light rays 1010 emanate from the reflective structure and travel in a direction of the viewer 1040. Light rays 1008 have reflected off of the interior surface of the reflective structure and are directed to the viewer 1040. An intensity of the light delivered to the viewer 1040 is increased by the reflective structure. In one embodiment, the reflective structure is a reflective cone. In one embodiment, the photoluminescent material 1006 is located inside of the reflective cone. Alternative reflective structure shapes such as boxes, cylinders, etc. may be used in alternative embodiments.

While the description above pertaining to FIG. 10 is, for simplicity's sake, directed to a single color element of a pixel, adjacent reflective structures 1014 and 1016 provide the similar functionality to the adjacent elements of photoluminescent material. Pixels may be single colored, as in a monochrome display, or plural cuplets 1012, 1014, 1016 may contain a corresponding plurality of photoluminescent systems, with exposure of the plurality of neighboring being combined as described above to produce colored pixels.

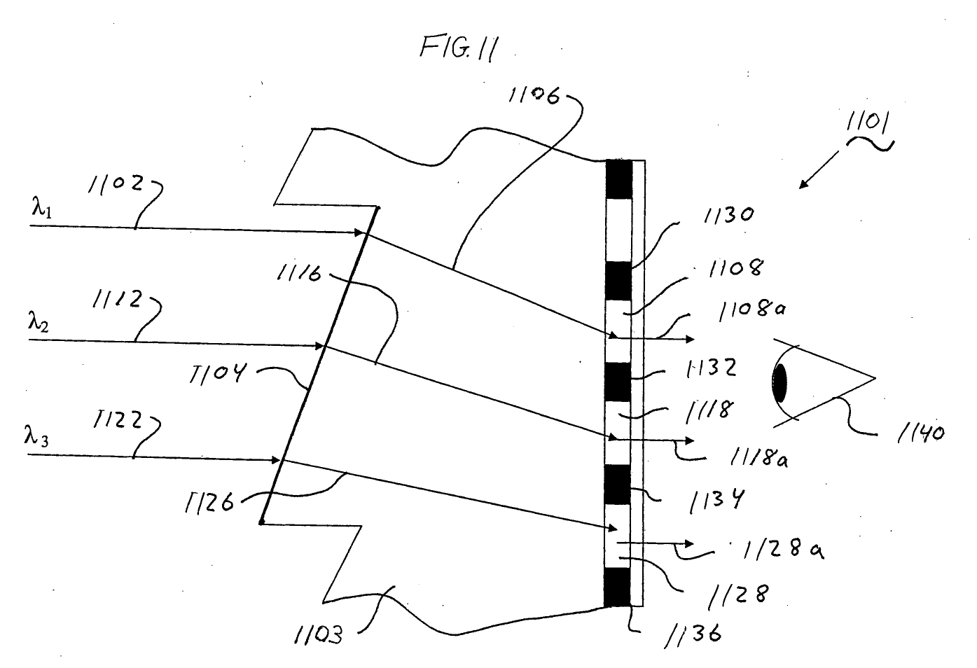

FIG. 11 is a cross-sectional diagram of a photoluminescent display screen 1101 comprising a refractive array according to an embodiment. A refractive array 1103 has a plurality of refractive elements, such as an element 1104 positioned to refract light at different wavelengths to individual photoluminescent elements. Individual beams of light, such as 1102, 1112, and 1122, at three different wavelengths may be combined with a beam combiner and the composite beam scanned, or alternatively the beams 1102, 1112, and 1122 scanned individually onto an element 1104 of the refractive array 1103. The refractive element 1104 directs light 1106 (at a first wavelength λ₁) to a first element of photoluminescent material 1108. Light 1106 is directed at a first angle by the refractive element 1104. Similarly, the refractive element 1104 directs light 1116 (at a second wavelength λ₂) to a second element of photoluminescent material 1118. Light 1126 is directed at a second angle by the refractive element 1104. Similarly, the refractive element 1104 directs light 1126 (at a third wavelength λ₃) to a third element of photoluminescent material 1128. Light 1116 is directed at a third angle by the refractive element 1104. The three photoluminescent elements 1108, 1118, 1128 and the refractive element 1104 may form a pixel with which an element of picture information, represented by emissions 1108a, 1118a, and 1128a are viewed by a viewer 1140.

A display screen may be formed by replicating the picture element shown in FIG. 11 to form an array of picture elements (pixels). Such an array may be a one dimensional or two dimensional array of pixels operable to produce pixels for viewing by a viewer 1140.

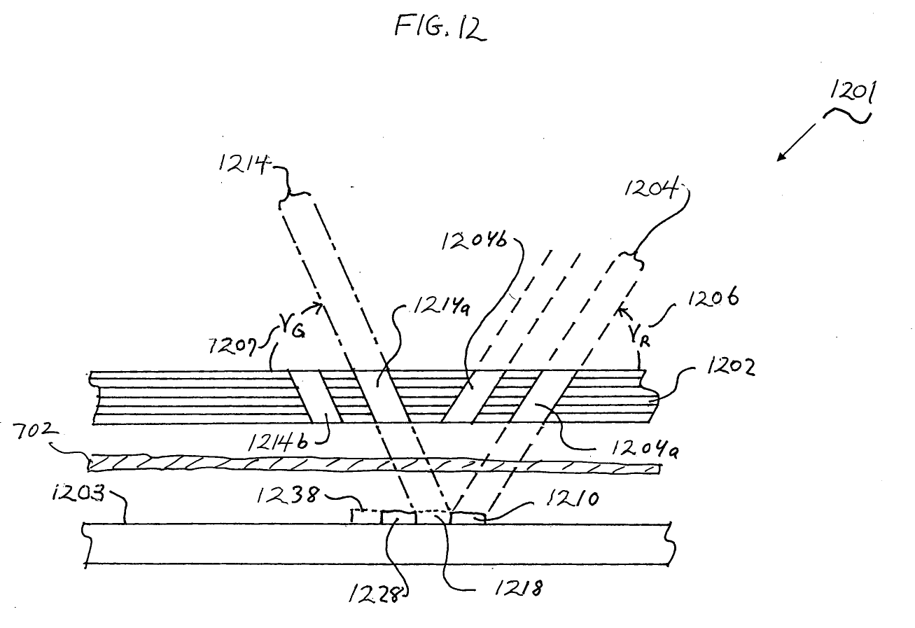

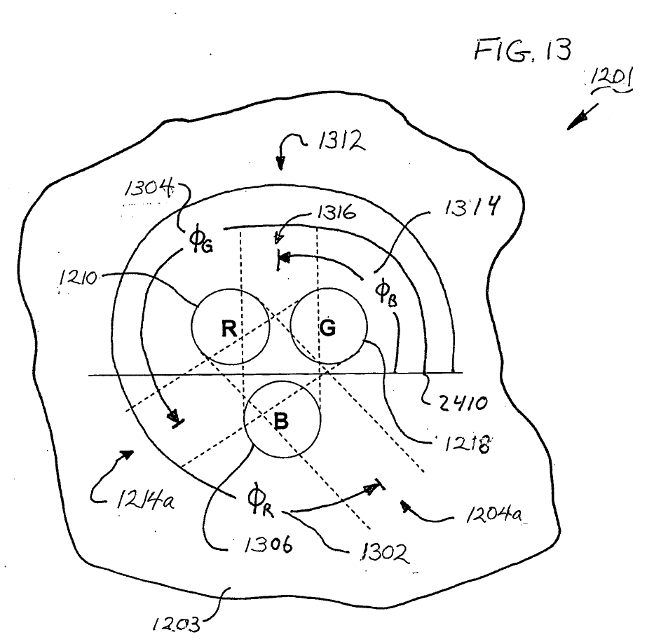

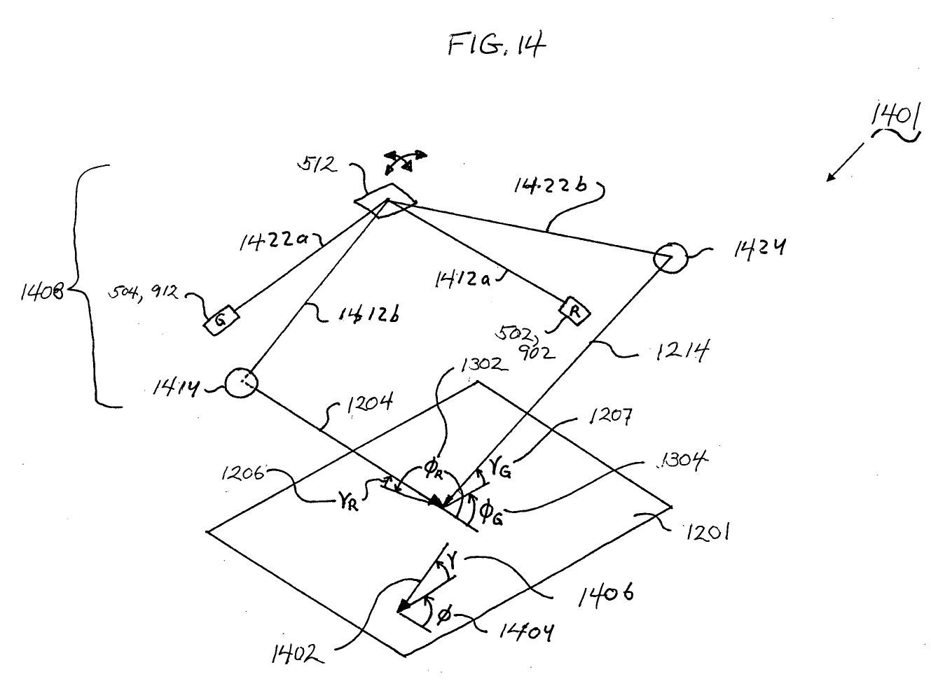

A plurality of beams of light configured to excite respective photoluminescent systems may be formed having particular approach angles to a photoluminescent screen. FIG. 12 is a cross-sectional diagram of a photoluminescent screen 1201 comprising a shadow mask 1202, according to an embodiment. FIG. 13 shows plan views of the arrays of photoluminescent systems of FIG. 12, and their placement and addressability angles, according to embodiments. FIG. 14 is a diagram showing a display apparatus 1401 operable to launch excitation beams of light toward the photoluminescent display screen 1201 of FIGS. 12-13 at particular angles, according to an embodiment.

According to embodiments illustrated by FIGS. 12-14, one may determine the operability of a particular beam (and the inoperability of other beams) to excite a subset of an array of photoluminescent systems. Such an array may alternatively be viewed as a superset of interposed or interstitial arrays of photoluminescent systems. According to some embodiments, each interposed array (or array subset) may comprise repeated instances of a particular photoluminescent system configured to photoluminescently emit a particular wavelength of light. According to embodiments illustrated by FIGS. 12-14, a first beam propagation path may be selected to excite a first interposed array, with other beam propagation paths being masked and therefore unable to excite the first interposed array. A second beam propagation path may similarly be selected to excite a second interposed array, and a third beam propagation path selected to excite a third interposed array, wherein each of the beam propagation paths is operable to address or excite its paired interposed array of photoluminescent systems, but inoperable to address or excite non-paired interposed arrays of photoluminescent systems. According to an embodiment, a shadow mask aligned between portions of the beam propagation paths and the interposed arrays of photoluminescent systems may be configured to provide incident angle selectivity.

Referring to FIG. 14, the direction of the beam of light 1402 impinging on a photoluminescent display screen 1201 may be defined by two angles. A first angle (φ) 1404 defines the rotation angle of the beam of light 1402 relative to display screen 1201. The first angle 1404 may be thought of as an azimuth coordinate. A second angle (γ) 1406 defines the angle between the plane of the photoluminescent display screen 1201 and the beam of light 1402. The second angle 1406 may be though of as an elevation coordinate.

Referring to FIG. 12, a first beam of light 1204A beam of light is scanned across a display surface to impinge upon regions of photoluminescent material such as a phosphorescent material or a fluorescent material. A shadow mask is disposed between the light source and the display surface so that only a portion of the spot area of the light beam can pass through the openings in the shadow mask and reach the display surface. A shadow mask can be made from a solid piece of material or from two pieces of material spaced apart with openings in each piece that are aligned at the angles necessary to allow the light beam to reach the proper photoluminescent material positioned beneath the shadow mask.

With reference to FIG. 12, a shadow mask 1202 is positioned above a display substrate 1203. A beam of light 1204 is directed at an angle γ_{R} 1206 relative to the planes of the shadow mask 1202 and substrate 1203. The light beam 1204 passes through a first open region 1204a defined by the shadow mask 1202. The shadow mask 1202 may be comprise of an opaque material to provide openings 1204a, 1204b, 1214a, and 1214b through which light may pass and opaque regions where light cannot pass. A first spot of photoluminescent material 1210 is aligned with opening 1204a such that when the beam of light 1204 is incident at the elevation angle γ_{R} 1206 and at an azimuth angle φ_{R} 1302 (visible in FIGS. 13 and 14) the first spot of photoluminescent material 1210 is illuminated by the beam 1204. The opaque material of the shadow mask 1202 defines a second open region 1204b through which the light beam 2304 may pass to illuminate a second photoluminescent spot 1228. In one embodiment, the first photoluminescent spot 1210 and the second photoluminescent spot 1228 emit the same color light when excited with light at an excitation wavelength. In one embodiment, the first photoluminescent spot 1210 is a color element of a first pixel and the second photoluminescent spot 1228 is a color element of a second pixel. According to an embodiment, photoluminescent spots 1210 and 1228 are configured to emit red light when excited by the excitation beam 1204. The azimuth and elevation angles 1302 and 1206 may thus be referred to as the red excitation beam coordinates and the angle of the apertures 1204a, 1204b are formed having corresponding angles. As may be appreciated, in some embodiments the apparent azimuth and elevation angles 1302, 1206 may vary across the photoluminescent display screen 1201 as the apparent angle to the beam source changes. According to some embodiments, the penetration angles of the apertures 1204a, 1204b may be varied across the plane of the shadow mask 1202 to correspond to the change in azimuth and elevation angels 1302, 1206 of the excitation beam. According to some embodiments, the apertures 1204a, 1204b may be formed somewhat oversize to accommodate changes in the beam angles and may thus be formed at constant angles across the plane of the shadow mask 1202. According to some embodiments, the apertures 1204a, 1204b may be formed in groups with each group having an azimuth and elevation angle 1302, 1206 selected to provide sufficient beam 1204 penetration across the group, for example by picking angles optimum for the central one of the group of apertures 1204a, 1204b. Trade-offs in screen excitation/emission uniformity, screen size, the ratio of diameters of the beam 1204 to the apertures 1204a, 1204b, the optical path length of the beam 1204 from an angle-defining optical element, etc. may be used to select the size and number of groups.

Another beam of light, 1214 is oriented to strike the shadow mask at an elevation angle γ_{G} 1207 and at an azimuth angle φ_{G} 1304 (visible in FIGS. 13 and 14) a third spot of photoluminescent material 1218 is illuminated thereby. A fourth open region 1214b is defined by the shadow mask 1202 and is also positioned to allow the beam of light 1214 to pass through and to illuminate a fourth photoluminescent material 1238. Photoluminescent spots 1218 and 1238 may emit a common color of light, different than photoluminescent spots 1210 and 1228. In one embodiment, photoluminescent spots 1218 and 1238 are configured to emit green light when impinged by an excitation beam 1214. The elevation and azimuth angles 1207, 1304 may be referred to as the green excitation coordinates. As with the red excitation coordinates discussed above, the angles may vary with position and may be accommodated in various ways.

Blue excitation beams and photoluminescent emission spots (not shown in FIG. 12) may have similar structure and operational considerations.

With reference to FIG. 13, an arrangement of photoluminescent elements is shown in the plane of a photoluminescent display screen 1201, according to an embodiment. In one embodiment, a pixel 1312 comprises three different colored photoluminescent materials. A first photoluminescent material spot 1210 is illustrated. An opening in a shadow mask is indicated at 1204a. The opening 1204a has an angle φ_{R}, indicated at 1302.

A second photoluminescent spot 1218 is illustrated on the photoluminescent display screen 1201. An opening in a shadow mask is indicated at 1214a, the opening 1214a making an azimuth angle φ_{G} 1214a.

A third photoluminescent material 1306 is illustrated on the substrate surface 1203. An opening in a shadow mask is indicated at 1316, the opening 1316 making an azimuth angle φ_{B} 1314. Together, the photoluminescent materials 1210, 1218, and 1306 are illuminated by separate beams of light incident upon the shadow mask at angles selected to permit the beams of light to pass through the openings. While the incident beams shown in FIGS. 12-14 are shown having both individual azimuth angles and individual elevations, a similar effect may be achieved may keeping one of the azimuth and elevation angles constant and varying the other of the azimuth and elevation angles.

FIG. 14 is a diagram of a photoluminescent display 1401 including excitation light beam sources and scanning system 1408 and a photoluminescent display screen 1201, according to an embodiment. A first light source 502, 902 emits light 1412a at an excitation wavelength and is scanned by a scanning assembly 512 to create a scanned beam 1412b. The scanned beam 1412b is reflected from a turning mirror 1414 to create a scanned incident light beam 1204 that selectively illuminates the photoluminescent screen 1201 and the shadow mask at selected azimuth and elevation angles 1302 and 1206, respectively. As described above, directional apertures in the shadow mask are positioned to permit the scanned beam 1204 to illuminate corresponding photoluminescent spots disposed beneath the apertures. The light source 502, 902 may be at a wavelength selected to excite corresponding photoluminescent spots configured to emit red light. As shorthand, one may refer to the light source 502, 902 as the red excitation light source, or even simply the red light source, however the actual wavelength of the beam, according to the illustrated embodiment, is not red but rather is a shorter or longer wavelength that is converted to red emissions by the corresponding photoluminescent materials.

A second light source 504, 912 emits a beam of light 1422a at an excitation wavelength. The beam 1422 impinges on a scanning assembly 512 and is scanned thereby to create a scanned beam 1422b. The scanned beam 1422b is reflected by a turning mirror 1424 to form a scanned incident excitation beam 1214 that illuminates the photoluminescent display screen 1201 and the shadow mask at azimuth and elevation angles 1304, 1207 corresponding to the excitation of green emitting photoluminescent spots. Additional light sources and turning mirrors may be added as needed to provide a color display according to various embodiments of the invention.

Referring back to FIG. 12, a partially reflective material 702 may be included in the system to reflect photoluminescently emitted light toward a viewing area. Such a material may operate and be constructed similarly to the description corresponding to FIG. 6 (where the material is referenced as 614) and 7. Various positions are possible. A location between the shadow mask and the array of photoluminescent spots as shown may provide for relatively high gain, manufacturability, etc. While the structure of the photoluminescent panel 1201 in FIG. 12 is illustrated as comprising separate structures, the substrate 1203 (with photoluminescent spots residing thereon), optional selective reflector 702, and shadow mask 1202 may be constructed substantially monolithically, in other words, as an integrated panel assembly.

In one embodiment, multiple scanners may be used to provide diversity of arrival angles for the beams of light incident upon a shadow mask. In another embodiment, multiple scanners may be used with turning mirrors to direct the beams of light to the shadow mask. While the turning mirrors 1414 and 1424 are shown as being relatively small relative to the extent of the photoluminescent display screen 1201, they may and generally should be increased in size sufficiently to allow the beams to have sufficient scanning distance to illuminate the entire photoluminescent panel. According to some embodiments, segmented turning mirrors may be used to create a particular incidence angle across a certain scan angle and another particular incidence angle across another scan angle. Such an approach may be used to allow a single light source to provide excitation energy for a plurality of color channels (providing the wavelength is or may be tuned to remain consistent with the absorption profiles of the various photoluminescent systems).

In various embodiments, the wavelength conversion techniques described herein provide improved display resolution. For example, if green light at approximately 550 nanometers is generated by scanning violet light at approximately 410 nanometers, the ratio of the wavelengths is 1.34. A flat scan mirror which would have yielded a pixel count of 800 pixels per line now has a pixel count of 1073 pixels. The “mega pixel” rating of the display is proportional to the square of the linear improvement. Therefore, by using violet to address the display screen, the resolution or “mega pixel” rating may be improved by a factor of 1.8.

Although the invention has been described herein by way of exemplary embodiments, variations in the structures and methods described herein may be made without departing from the spirit and scope of the invention. For example, the positioning of the various components may be varied. For example, the excitation light sources may be positioned to provide a front-projection or a rear-projection photoluminescent display. Moreover, embodiments may use raster scan patterns as is common to video displays, bidirection raster scan patters, “stroke” or “calligraphic” vector scan patterns, or other scan patterns according to the application. Further, although the input signal is described as coming from an electronic controller or predetermined image input, one skilled in the art will recognize that a portable video camera (alone or combined with the electronic controller) may provide the image signal. This configuration would be particularly useful in simulation environments involving a large number of participants, since each participant's video camera could provide an image input locally, thereby reducing the complexity of the control system.

While embodiments have been described relatively generically, various specific applications are contemplated. For example, a photoluminescent display panel may form a viewable portion of a display similar to LCD, CRT, and other panel and tube display technologies. Additionally or alternatively, systems described herein may be used in the construction and operation of projection display systems wherein the photoluminescent screen or panel itself is not viewed directly, but rather light emitted by the photoluminescent panel is projected to provide a viewable display in another form. For example, a photoluminescent panel may fill the roll of an exit pupil expander in a projection display system operable as a near-eye or head-mounted display (HMD). The photoluminescent panel may similarly provide an image source for rays of light that are projected to an “eye box” or viewing region, such as in a heads-up-display (HUD).

While the description herein has tended to focus specifically on photoluminescent wavelength conversion, embodiments are contemplated that combine visible light beams of light with photoluminescently converted beams of light. Some discussion of mixed systems is presented above in conjunction with discussion related to FIG. 2. But it is also within the scope to replace one or more excitation light beams with viewable beams in other embodiments. For example, referring to FIG. 6, the light beams 610 and/or 618 may be accompanied by other light beams at visible wavelengths that impinge upon and are diffused by the screen 601. According to some embodiments, the diffused light intensity pattern (e.g. hemispherical or Lambertian light scattering) may be matched to photoluminescent emission intensity pattern to provide a desired color balance across viewing angles. Similarly, one or more of the beams 1204, 1214 may be provided at a desired viewing wavelength and the corresponding “photoluminescent” spot 1210, 1218 replaced with a diffusing spot, diffractive spot, ordered array refracting spot, etc. configured to broaden the transmission angle of the incident light beam transmitted through the substrate 1203, rather than wavelength convert the incident light beam.

For purposes of discussing and ease of understanding embodiments have been described in specific terms. Those of skill in the art will recognize that the invention is not limited to the embodiments described, but can be practiced with modification and alteration within the spirit and scope of the appended claims.

What is claimed is:

1. A method for displaying an image comprising:
generating a first modulated and scanned excitation beam;
generating a second modulated and scanned excitation beam;
impinging the first and second modulated and scanned excitation beams onto a photoluminescent screen; and
responsively converting the wavelengths of the first and second excitation beams into different corresponding third and fourth visible wavelength photoluminescent emissions in a manner configured to substantially prevent cross-talk;
wherein preventing cross-talk comprises preventing the first modulated and scanned excitation beam from stimulating photoluminescent emissions at the fourth visible wavelength and preventing the second modulated and scanned excitation beam from stimulating photoluminescent emissions at the third visible wavelength.

2. The method of claim 1 wherein substantially preventing cross-talk comprises generating the first excitation beam at a first wavelength corresponding to the absorption spectrum of a first photoluminescent system configured to responsively emit light at the third visible wavelength, and generating the second excitation beam at a second wavelength corresponding to the absorption spectrum of a second photoluminescent system configured to responsively emit light at the fourth visible wavelength;
and wherein the first wavelength does not correspond to the absorption spectrum of the second photoluminescent system and the second wavelength does not correspond to the absorption spectrum of the first photoluminescent system.

3. The method of claim 2 wherein the stimulation of the first and second photoluminescent systems occurs in separate layers of the photoluminescent screen.

4. The method of claim 2 wherein the stimulation of the first and second photoluminescent systems occurs in separate respective first and second layers of the photoluminescent screen and wherein a selectively reflective layer substantially prevents excitation light at the first wavelength from penetrating to the second layer.

5. The method of claim 2 wherein the stimulation of the first and second photoluminescent systems occurs in separate respective first and second layers of the photoluminescent screen and wherein a selectively reflective layer substantially reflects excitation light at the first wavelength back through the first layer.

6. The method of claim 1 wherein substantially preventing cross-talk further comprises:
impinging the first modulated and scanned excitation beam onto the photoluminescent screen at a first angle; and
impinging the second modulated and scanned excitation beam onto the photoluminescent screen at a second angle.

7. The method of claim 6 wherein the photoluminescent screen comprises a shadow mask configured to pass the beam of impinging light at the first angle to illuminate a first photoluminescent system configured to responsively emit light at the third visible wavelength and to block the beam of impinging light at the second angle from illuminating the first photoluminescent system.

8. The method of claim 1 further comprising reflecting a portion of the third and fourth visible wavelength photoluminescent emission toward a viewing region.

9. The method of claim 1 further comprising preventing excitation light from reaching a viewer.

10. An electronic display comprising;
a plurality of light sources operable to selectively emit a corresponding plurality of beams of excitation light;
a beam scanning apparatus aligned to receive the plurality of beams of excitation light and scan the plurality of beams of excitation light;
a layered photoluminescent display screen having layers of photoluminescent material, aligned to receive the scanned plurality of beams of excitation light and configured to allow only one of the plurality of beams of excitation light to reach a corresponding layer of photoluminescent material.

11. The electronic display of claim 10 wherein the plurality of beams of excitation light are at different wavelengths and wherein the layered photoluminescent display screen includes wavelength-selective reflective layers configured to pass or reflect excitation light depending upon wavelength.

12. The electronic display of claim 10 wherein the plurality of beams of excitation light are at different wavelengths and wherein the layered photoluminescent display screen includes wavelength-selective reflective layers arranged between the layers of photoluminescent material, the wavelength-selective reflective layers being configured to pass or reflect excitation light depending upon wavelength.

13. The electronic display of claim 10 wherein the layered photoluminescent display screen comprises a wavelength-selective reflective layer configured to pass light at the wavelengths of the excitation light and reflect light at the wavelengths of light emitted by the layers of photoluminescent material.

14. The electronic display of claim 10 wherein the layered photoluminescent display screen comprises a wavelength-selective reflective layer configured to reflect light at the wavelengths of the excitation light and pass light at the wavelengths of light emitted by the layers of the photoluminescent material.

15. A photoluminescent video display comprising:
an excitation beam scanning system operable to scan at least one excitation beam onto a field of view at a plurality of selected angles;
a photoluminescent display screen aligned with the field of view and configured to pass excitation light at a first angle to reach a first plurality of photoluminescent spots and pass excitation light at a second angle to reach a second plurality of photoluminescent spots.

16. The photoluminescent video display of claim 15 wherein the excitation beam scanning system comprises a plurality of excitation light sources.

17. The photoluminescent video display of claim 15 wherein the excitation beam scanning system comprises a plurality of turning mirrors configured to impart the plurality of selected angles upon the scanned excitation beam.

18. The photoluminescent video display of claim 15 wherein the photoluminescent display screen comprises a shadow mask having a plurality of apertures configured to selectively pass the excitation light depending on the angle of the received excitation light beam.

19. The photoluminescent video display of claim 15 wherein the photoluminescent display screen comprises a layer of reflective material configured to pass light corresponding to a wavelength of the excitation beam and to reflect light corresponding to a photoluminescently emitted wavelength.

20. The photoluminescent video display of claim 15 wherein the photoluminescent display screen comprises a layer of reflective material configured to reflect light corresponding to a wavelength of the excitation beam and to pass light corresponding to a photoluminescently emitted wavelength.
